(19) United States
(12) Patent Application Publication
(10) Pub. No.: US 2009/0238391 A1
(43) Pub. Date: Sep. 24, 2009

(54) VIBRATION ABSORBING MEMBER AND AUDIO APPARATUS USING THE SAME

(75) Inventor: TAO WANG, Shenzhen City (CN)

Correspondence Address: PCE INDUSTRY, INC.;ATT. Steven Reiss, 458 E. LAMBERT ROAD, FULLERTON, CA, 92835, US

(73) Assignees: HONG FU JIN PRECISION INDUSTRY (ShenZhen) Co., LTD., Shenzhen City (CN); HON HAI PRECISION INDUSTRY CO., LTD., Tu-Cheng (TW)

(21) Appl. No.: 12/350,170

(22) Filed: Jan. 7, 2009

(30) Foreign Application Priority Data
Mar. 24, 2008 (CN) 200810300679.0

(51) Int. Cl. H04R 1/02

(52) U.S. Cl. 381/347

(57) ABSTRACT

An audio apparatus includes a speaker having an output surface from which sound waves of the speaker radiate out; and a vibration absorbing member housing the speaker therein. The vibration absorbing member including a vibration absorbing portion attached to the output surface of the speaker, and a fastening portion connecting and surrounding the vibration absorbing portion and sleeves on the speaker configured for attaching the vibration absorbing member to the speaker. The vibration absorbing portion defining a through hole for allowing the sound waves from the speaker to radiate out.

### BACKGROUND

1. Field of the Invention

Embodiments of the present disclosure generally relate to absorbers, and particularly, to a vibration absorbing member and an audio apparatus using the same.

2. Description of Related Art

Audio apparatus generally includes a speaker and a plate-like vibration absorbing member. An opening is defined in a front surface of the speaker for allowing sound waves reproduced by the speaker to radiate out of the audio apparatus. The vibration absorbing member is detachably attached to the speaker at the front surface of the speaker, with a through hole of the vibration absorbing member corresponding to the opening of the speaker.

When the speaker is assembled in a cabinet, the vibration absorbing member is disposed between the speaker and the cabinet the vibration absorbing member may separate from the speaker if the speaker is not tightly attached to the vibration absorbing member.

As such, a need exists for a vibration absorbing member that can be tightly attached to the speaker.

### BRIEF DESCRIPTION OF THE DRAWINGS

FIG. 1 is an isometric view of an audio apparatus in accordance with an exemplary embodiment.

FIG. 2 is an exploded perspective view of the audio apparatus of FIG. 1.

FIG. 3 is an exploded perspective view of the audio apparatus of FIG. 1 viewed from a reverse angle of FIG. 1.

FIG. 4 is a cross-sectional view of the audio apparatus of FIG. 1 taken along the line IV-IV of FIG. 1.

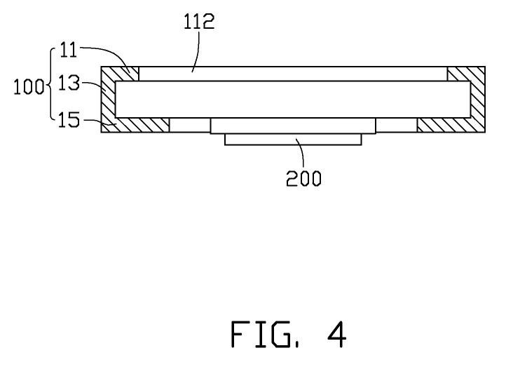

### DETAILED DESCRIPTION

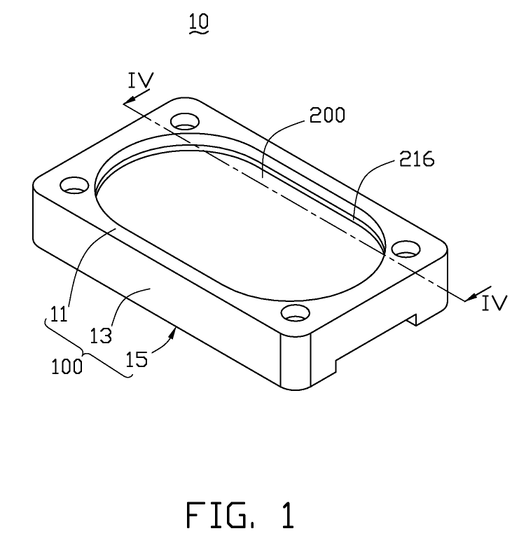

Referring to FIG. 1, an audio apparatus 10 in accordance with an exemplary embodiment includes a vibration absorbing member 100 and a speaker 200 disposed in the vibration absorbing member 100.

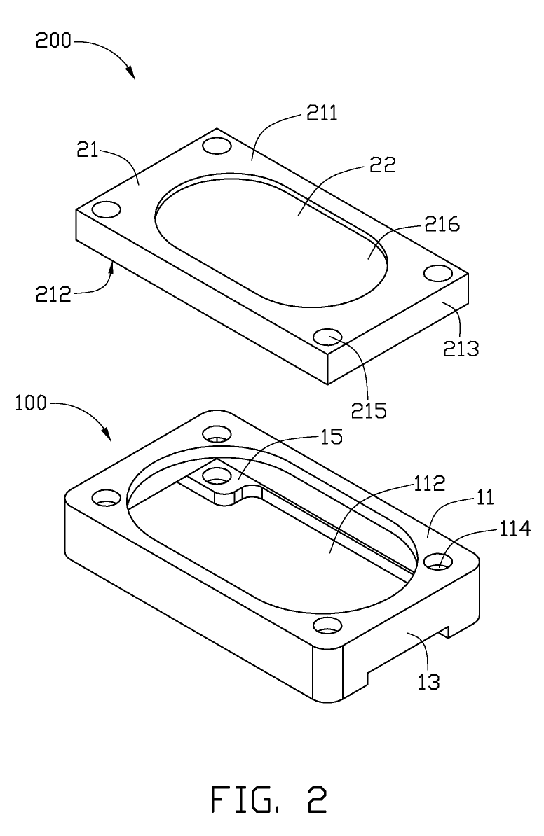

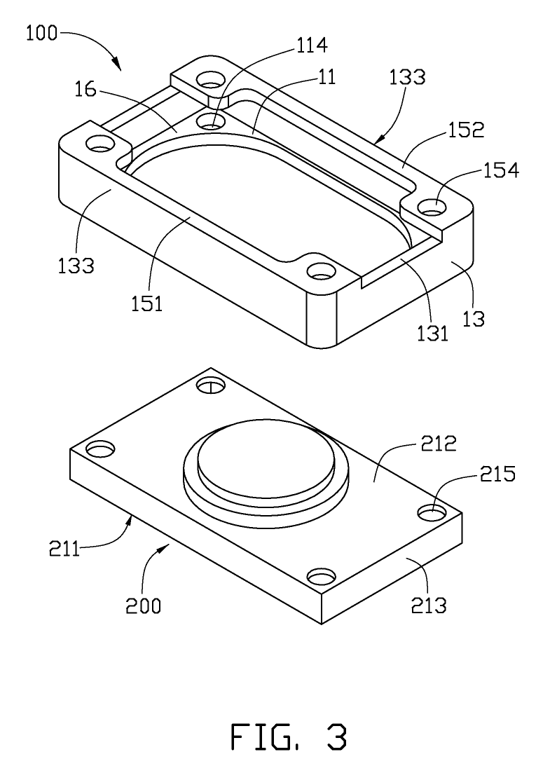

Further referring to FIGS. 2 and 3, the speaker 200 includes an approximately rectangular parallelepiped frame 21 and an electroacoustical transducer 22 disposed in the frame 21.

The electroacoustical transducer 22 is a sound source generator of the speaker 200. The electroacoustical transducer 22 includes a diaphragm, a voice coil, a pole piece, and so on (not shown).

The frame 21 has a front surface 211, a back surface 212, and a side surface 213 connecting and surrounding the front surface 211 and the back surface 212. The frame 21 defines four first through holes 215 extending from the front surface 211 to the back surface 212. An opening 216 is defined in the front surface 211 of the frame 21. The opening 216 is used for allowing sound reproduced by the electroacoustical transducer 22 to radiate out of the speaker 200.

The vibration absorbing member 100 is made of flexible material, such as rubber, sponge, and so on. The vibration absorbing member 100 is integrally formed. The vibration absorbing member 100 defines an approximately rectangular parallelepiped housing 16 for receiving the speaker 200 and absorbing vibration of the speaker 200. The size of the housing 16 is slightly smaller than that of the speaker 200, such that the vibration absorbing member 100 can tightly enclose the speaker 200. The vibration absorbing member 100 includes a plate-like vibration absorbing portion 11, a fastening portion 13, and a sub-fastening portion 15. The fastening portion 13 connects the vibration absorbing portion 11 with the sub-fastening portion 15.

The vibration absorbing portion 11 is used for absorbing vibration of the speaker 200. The vibration absorbing portion 11 defines a through hole 112 corresponding with the opening 216 of the speaker 200 for allowing the sound from the opening 216 to radiate out, and four second through holes 114 corresponding with the four first through holes 215 of the speaker 200.

The fastening portion 13 includes four sidewalls vertically extending from four edges of the vibration absorbing portion 11. Each of the four sidewalls is rectangle-shaped. The fastening portion 13 is capable of tightly sleeving the side surface 213, such that the vibration absorbing member 100 can be attached to the speaker 200.

The sub-fastening portion 15 includes two fastening plates 151, 152 parallel with the vibration absorbing portion 11. The two fastening plates 151, 152 respectively connect with two opposite side edges 133 of the fastening portion 13. The two fastening plates 151, 152 are spaced apart from each other, and define a space 131 therebetween to allow the speaker 200 to be easily inserted into the vibration absorbing member 100 through the space 131. The two fastening plates 151, 152 define four third through holes 154 corresponding with the four second through holes 114 and the four first through holes 215. The first, second, and third through holes 215, 114, 215 allow fastening members (not shown), such as screws, to pass through, in order for the speaker 200 to be fastened to the vibration absorbing member 100.

In assembly, the speaker 200 is inserted into the vibration absorbing member 100 from the space 131 between the two fastening plates 151, 152, and the front surface 211 faces the vibration absorbing portion 11. Because the fastening portion 13 tightly sleeves the side surface 213 of the speaker 200, the vibration absorbing portion 11 is tightly attached to the front surface 211, and the two fastening plates 151, 152 are tightly attached to the back surface 212. As a result, the vibration absorbing member 100 can tightly attached on the speaker 200.

It is to be understood, however, that even though numerous characteristics and advantages of the present disclosure have been set forth in the foregoing description, together with details of the structure and function of the present disclosure, the present disclosure is illustrative only, and changes may be made in detail, especially in matters of shape, size, and arrangement of parts within the principles of the present disclosure to the full extent indicated by the broad general meaning of the terms in which the appended claims are expressed.

What is claimed is:

1. An audio apparatus comprising:
a speaker having an output surface from which sound waves of the speaker radiate out; and
a vibration absorbing member housing the speaker therein, the vibration absorbing member comprising:
a vibration absorbing portion attached to the output surface of the speaker, the vibration absorbing portion defining a through hole for allowing the sound waves from the speaker to radiate out; and
a fastening portion connecting and surrounding the vibration absorbing portion and sleeving the speaker.
wherein the fastening portion is configured for attaching the vibration absorbing member to the speaker.

2. The audio apparatus as claimed in claim 1, wherein the vibration absorbing member comprises a sub-fastening portion connecting with the fastening portion and tightly attached to a back surface opposite to the front surface of the speaker.

3. The audio apparatus as claimed in claim 2, wherein the sub-fastening portion connects with edges of the fastening portion away from the vibration absorbing portion.

4. The audio apparatus as claimed in claim 3, wherein the sub-fastening portion comprises two fastening plates parallel with the vibration absorbing portion.

5. The audio apparatus as claimed in claim 4, wherein the two fastening plates are spaced apart from each other.

6. The audio apparatus as claimed in claim 2, wherein a housing is formed among the fastening portion, the sub-fastening portion and the vibration absorbing portion, a size of the housing is smaller than the speaker.

7. The audio apparatus as claimed in claim 1, wherein the vibration absorbing member is made of flexible material.

8. The audio apparatus as claimed in claim 7, wherein the vibration absorbing member is made of rubber or sponge.

9. The audio apparatus as claimed in claim 1, wherein the fastening portion includes sidewalls extending from edges of the vibration absorbing portion.

10. The audio apparatus as claimed in claim 1, wherein the fastening portion connects vertically with edges of the vibration absorbing portion.

11. The audio apparatus as claimed in claim 1, wherein the vibration absorbing member is integrally formed.

12. A vibration absorbing member for housing a speaker therein, the speaker having a front surface from which sound waves of the speaker radiate out, the vibration absorbing member comprising:
a vibration absorbing portion attached to the front surface and defining a through hole for allowing the sound waves to radiate out; and
a fastening portion connecting with the vibration absorbing portion and sleeving the speaker for attaching the vibration absorbing member to the speaker.

13. The vibration absorbing member as claimed in claim 12, wherein the vibration absorbing member is made of flexible material.

14. The vibration absorbing member as claimed in claim 12, wherein the vibration absorbing member comprises a sub-fastening portion connecting with the fastening portion and tightly attached to a back surface opposite to the front surface of the speaker.

15. The vibration absorbing member as claimed in claim 14, wherein the sub-fastening portion connects with a free end of the fastening portion away from the vibration absorbing portion.

16. The vibration absorbing member as claimed in claim 15, wherein the sub-fastening portion comprises two fastening plates spaced apart from each other parallel with the vibration absorbing portion.

17. An audio apparatus comprising:
a speaker having an output surface from which sound waves of the speaker radiate out; and
a vibration absorbing member and attached to the speaker, the vibration absorbing member defining:
a housing for receiving a speaker; and
a through hole communicating with the housing, the through hole defined in a portion of the vibration member which is attached to the output surface of the speaker for allowing the sound waves from the speaker to radiate out.
